(19) United States
(12) Patent Application Publication
(10) Pub. No.: US 2017/0216727 A1
(43) Pub. Date: Aug. 3, 2017

(54) METHOD OF IN-GAME ADVERTISING

(71) Applicants: Chien-Hua Tsao, Taipei City (TW); Ta-Wei Tsao, Taipei City (TW); Steven Tsao, Taipei City (TW)

(72) Inventors: Chien-Hua Tsao, Taipei City (TW); Ta-Wei Tsao, Taipei City (TW); Steven Tsao, Taipei City (TW)

(21) Appl. No.: 15/414,396

(22) Filed: Jan. 24, 2017

(30) Foreign Application Priority Data
Feb. 2, 2016 (TW) 105103222

(51) Int. Cl. A63F 13/61; A63F 13/537; A63F 13/35

(52) U.S. Cl. CPC A63F 13/61; A63F 13/35; A63F 13/537

(57) ABSTRACT

A method of in-game advertising includes steps of: (a) communicatively connecting an electronic device to a game server via a communication network, the game server including a game item and an advertisement item that corresponds to the game item; (b) the electronic device receiving game data of the game item and advertisement information of the advertisement item from the game server; and (c) the electronic device generating and displaying game content of the game item in a first display area according to the game data, and displaying the advertisement information of the advertisement item in a second display area that is non-overlapping with the first display area.

### CROSS-REFERENCE TO RELATED APPLICATION

This application claims priority of Taiwanese Patent Application No. 105103222, filed on Feb. 2, 2016.

### FIELD

The disclosure relates to an advertising method, and more particularly to a method of in-game advertising.

### BACKGROUND

Traditionally, electronic game companies earn profit by selling games to players. Recently, a popular way of profit-earning for electronic game companies is to provide in-game advertising service to advertisers. In addition, some electronic game companies would give a portion of the profit earned from the advertisers back to the players, so the players may make additional income while playing games.

In conventional in-game advertising, advertisements are inserted during execution of the game when, for example, the game is paused by the player, so the advertisements may easily be ignored by the players, and the advertising period only occupies a small portion of the entire gaming period.

### SUMMARY

According to the disclosure, a method of in-game advertising includes steps of: (a) communicatively connecting an electronic device to a game server via a communication network, the game server including a game item and an advertisement item that corresponds to the game item; (b) the electronic device receiving game data of the game item and advertisement information of the advertisement item from the game server; and (c) the electronic device generating and displaying game content of the game item in a first display area according to the game data, and displaying the advertisement information of the advertisement item in a second display area that is non-overlapping with the first display area.

According to the disclosure, a method of in-game advertising is implemented by a game server that communicatively coupled to an electronic device via a communication network. The game server includes a game item and an advertisement item that corresponds to the game item. The method includes a step of the game server transmitting game data of the game item and advertisement information of the advertisement item to the electronic device. The game data causes, after execution by the electronic device, the electronic device to generate and display game content of the game item in a first display area, and to display the advertisement information of the advertisement item in a second display area that is non-overlapping with the first display area.

According to the disclosure, an in-game advertising system includes a game server communicatively coupled to an electronic device via a communication network, including a game item and an advertisement item that corresponds to the game item, and configured to transmit game data of the game item and advertisement information of the advertisement item to the electronic device in response to a specific user operation from the electronic device. The game data causes, after execution by the electronic device, the electronic device to generate and display game content of the game item in a first display area, and to display the advertisement information of the advertisement item in a second display area that is non-overlapping with the first display area.

### BRIEF DESCRIPTION OF THE DRAWINGS

Other features and advantages of the disclosure will become apparent in the following detailed description of the embodiment (s) with reference to the accompanying drawings, of which:

FIG. 1 is a block diagram illustrating a game server and an electronic device exemplified to implement an embodiment of the method of in-game advertising according to the disclosure;

FIG. 2 is a block diagram illustrating the game server including multiple game items and multiple advertisement types.

FIG. 3 is a flow chart illustrating steps of the embodiment of the method of in-game advertising according to this disclosure; and

FIGS. 4 to 6 are schematic diagrams illustrating an implementation of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

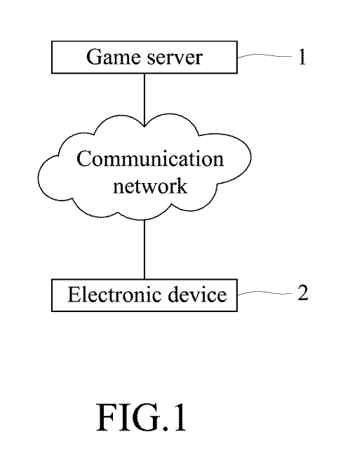

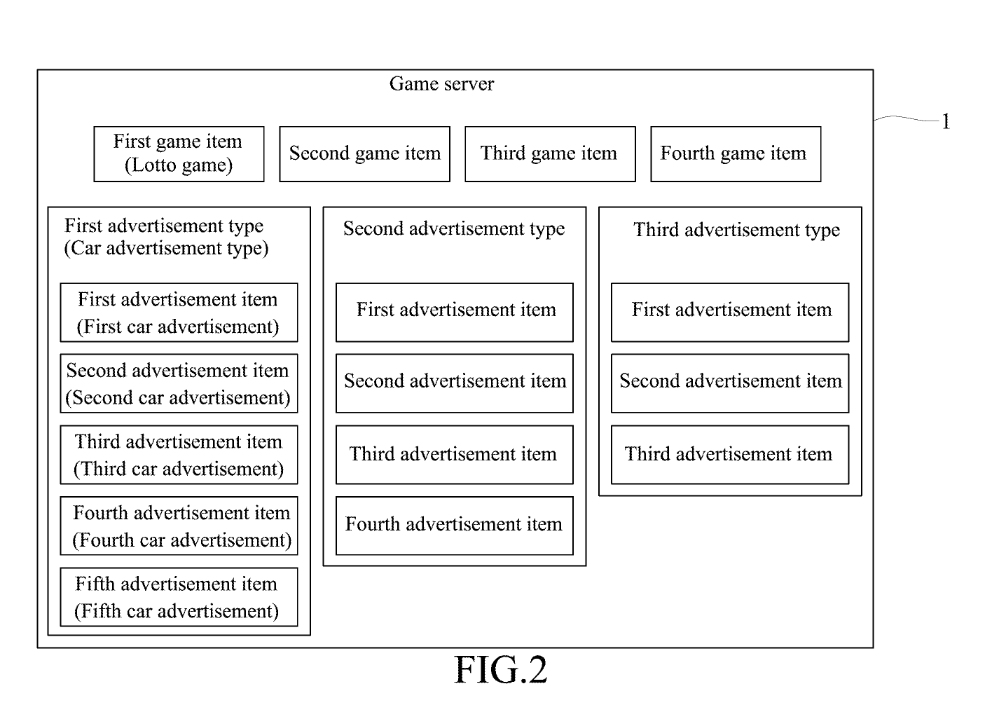

Referring to FIGS. 1 and 2, the embodiment of the method of in-game advertising according to this disclosure is implemented using a game server 1 and an electronic device 2 (e.g., a smartphone, a tablet computer, a desktop computer, etc.) that are communicatively coupled together via a communication network (e.g., the Internet). The game server 1 includes a plurality of game items and advertisement information of multiple advertisement types. Each advertisement type may include a plurality of advertisement items. In this disclosure, the electronic device 2 is exemplified using a smartphone that executes a specific gaming program to communicate with the game server 1 for implementing the embodiment of the in-game advertising method.

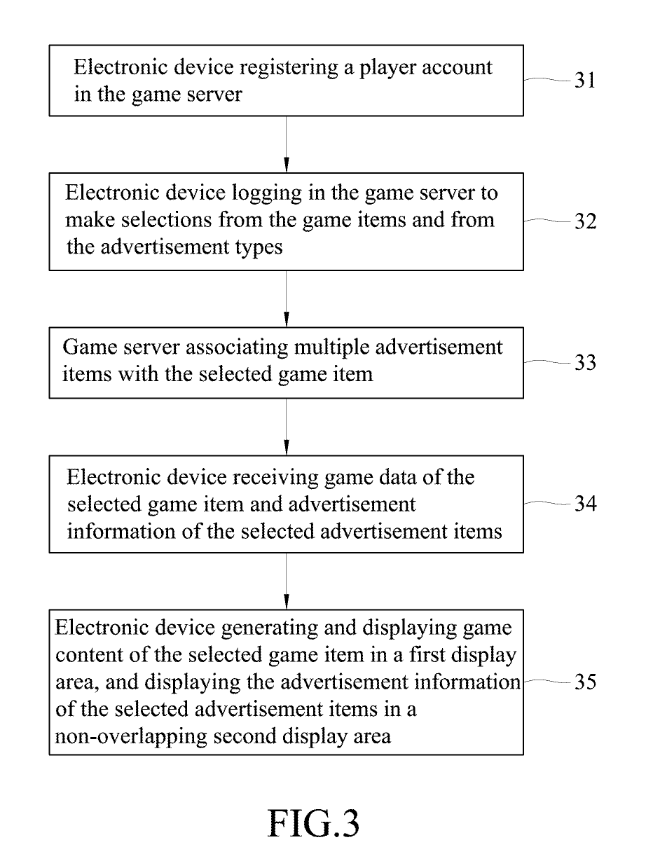

Referring to FIG. 3, the embodiment of the in-game advertising method includes steps 31-35.

In step 31, the electronic device 2 is operated by a game player (i.e., the user of the electronic device 2) to register a player account in the game server 1.

In step 32, the electronic device 2 is operated by the game player to log in the game server 1 with the player account and to make selections from the game items and from the advertisement types.

In step 33, the game server 1 associates multiple advertisement items that correspond to the advertisement type selected in step 32 with the game item selected in step 32. In one implementation, the game server 1 may randomly select some of the advertisement items that correspond to the selected advertisement type or select a number of the advertisement items that correspond to the selected advertisement type according to a specific sequence for association with the game item.

For example, when the game item and the advertisement type selected by the game player operating the electronic device 2 are respectively “lotto game” and “car advertisement”, the game server 1 may associate advertisement items of “first car advertisement”, “second car advertisement” and “third car advertisement” with the lotto game.

In step 34, the electronic device 2 is operated by the game player to receive, from the game server 1, game data of the selected game item and advertisement information of the advertisement items that are associated with the selected game item in step 33.

In step 35, the electronic device 2 is operated by the game player to execute the received game data for playing the selected game item. The executed game data causes the electronic device 2 to generate and display game content of the selected game item in a first display area of the electronic device 2 according to the game data, and to display the advertisement information of the advertisement items associated with the selected game item in a second display area of the electronic device 2. The second display area is separate from, and non-overlapping with the first display area. It is noted that the game content and the advertisement information are displayed at the same time in the respective first display area and second display area. In one implementation, the display of the advertisement information of the advertisement items associated with the selected game item in the second display area of the electronic device 2 involves displaying advertisement information of individual advertisement items one at a time, but this disclosure is not limited thereto.

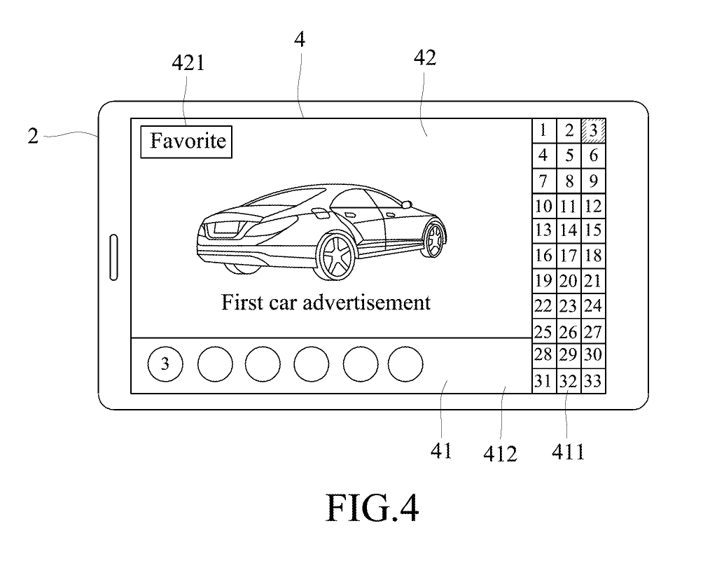

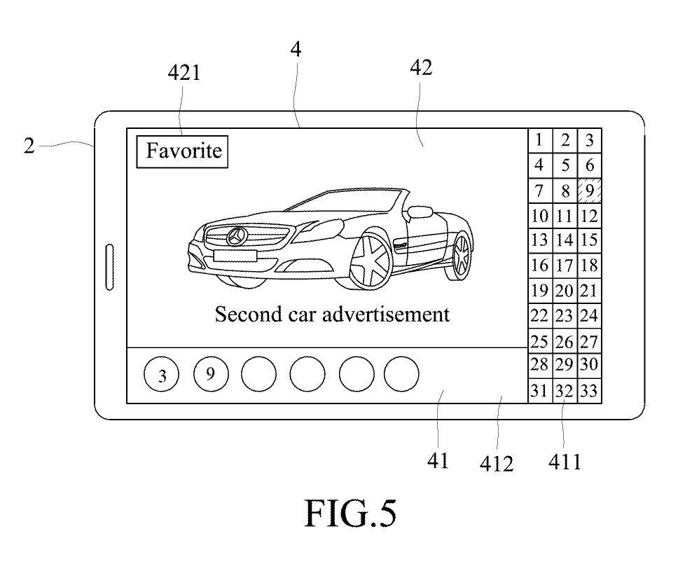

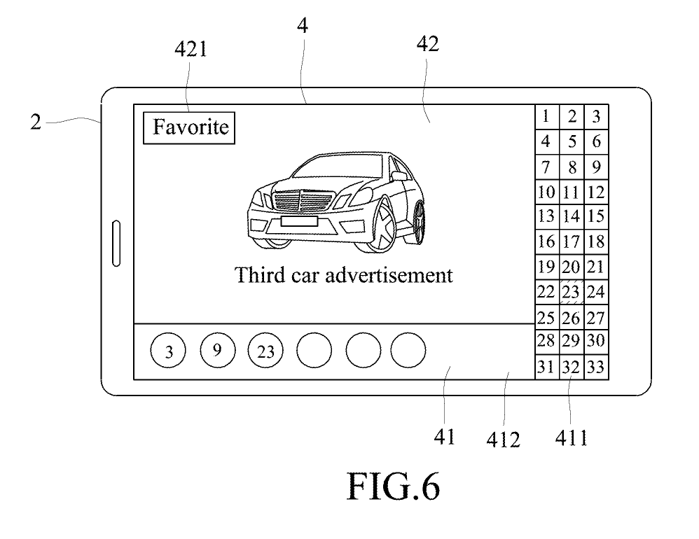

Referring to FIGS. 4-6, for example, when the electronic device 2 is operated to play the lotto game, the game content of the lotto game is displayed according to the game data, e.g., in the form of a user interface, in a first display area 41 that includes a candidate number zone 411 and a selected number zone 412. In this example, there are thirty three numbers displayed in the candidate number zone 411 for selection by the game player. When the game player operates the electronic device 2 to select a number from the candidate number zone 411, the electronic device 2 displays the selected number in the selected number zone 412. In a general lotto game, when the game player determines a combination of six numbers, and the combination is identical to a winning number combination, the game player may gain some rewards from the lotto game. The electronic device 2 may transmit reward information corresponding to the gained rewards to the game server 1, and the game server 1 makes a record of the reward information in the player account.

In one implementation of the embodiment for the exemplified lotto game, each candidate number (i.e., the number in the candidate number zone 411) corresponds to the “first car advertisement”, the “second car advertisement” or the “third car advertisement”. For instance, selecting a first one of the candidate numbers from the candidate number zone 411 through the electronic device 2 may trigger execution of a first operation instruction by the electronic device 2 according to the game data, causing the electronic device 2 to display, in the second display area 42, advertisement information of one of the car advertisements that corresponds to the first candidate number, and selecting a second one of the candidate numbers from the candidate number zone 411 through the electronic device 2 may trigger execution of a second operation instruction by the electronic device 2 according to the game data, causing the electronic device 2 to display, in the second display area 42, advertisement information of one (which may be the same one or another one) of the car advertisements that corresponds to the second candidate number. In other words, the electronic device 2 displays, in the second display area 42, advertisement information of one of the car advertisements (i.e., the advertisement items) that corresponds to the selected number. Each candidate number may randomly correspond to one of the car advertisements. For example, as shown in FIGS. 4-6, the number “3” randomly corresponds to the first car advertisement, so the electronic device 2 displays advertisement information of the first car advertisement in the second display area 42 when the number is selected; the number “9” randomly corresponds to the second car advertisement, so the electronic device 2 displays advertisement information of the second car advertisement in the second display area 42 when the number “9” is selected; and the number “23” randomly corresponds to the third car advertisement, so the electronic device 2 displays advertisement information of the third car advertisement in the second display area 42 when the number “23” is selected. In one implementation, correspondence between the candidate numbers and the car advertisements may be determined according to a specific sequence. For example, for N being an integer between 0 and 10, the number of “3N+1” may correspond to the first car advertisement, the number of “3N+2” may correspond to the second car advertisement, and the number of “3N+3” may correspond to the third car advertisement.

By virtue of displaying the game content in the first display area 41 and displaying the advertisement information in the second display area 42 at the same time, the advertisements may attract more attention from the game player in comparison to conventional in-game advertising. Since the display of the advertisement information is triggered by the user operation for the game, the game player would unavoidably notice the visible change in the displayed advertisement information, resulting in better advertising effect. In addition, since a total time length of displaying the advertisement information (of different advertisement items) is almost equal to the entire game-playing period, the owner of the game server 1 may acquire more advertising fee from the corresponding advertiser(s) due to the long advertising period, and may thus give more feedback to game players.

Furthermore, when the game player is interested in the advertisement information of a particular advertisement item displayed during the game play, the game player may operate the electronic device 2 to, for instance, save the advertisement information of the particular advertisement item, and a rewarding mechanism for saving advertisements may be arranged. In the example shown in FIGS. 4-6, the game data causes the electronic device 2 to display an interactive section in a form of a “Favorite” button 421 in the second display area 42, so the game player may operate the electronic device 2 to click the “Favorite” button 421, thereby triggering the electronic device 2 to save the car advertisement that is being displayed in the second display area 42, and then causing the lotto game to provide to the game player a reward (e.g., provided by the car advertiser) by means of the electronic device 2 transmitting reward information corresponding to the reward to the game server 1, and the game server 1 making a record of the reward information in the player account.

In one implementation of the embodiment for the lotto game, instead of triggering display of the different car advertisements by selecting the different numbers in the candidate number zone 411, the electronic device 2 may continuously and randomly select one of the car advertisements and display advertisement information of the randomly selected car advertisements in the second display area 42. In one implementation of the embodiment for the lotto game, the electronic device 2 may display advertisement information of the car advertisements one by one according to a specific sequence in the second display area 42. In other words, displaying the game content of the lotto game in the first display area 41 and displaying the advertisement information of the car advertisements in the second display area 42 are independently performed at the same time.

In another example, the game item and the advertisement type that are selected by the game player using the electronic device 2 may be a stage beating game and the car advertisement type, respectively, where the stage beating game may include multiple game stages/levels. The game server 1 may associate all of the advertisement items of the car advertisement type with the stage beating game. When the electronic device 2 is operated to play the stage beating game, the electronic device 2 displays the game content in the first display area 41, and displays advertisement information of one of the car advertisements (i.e., the advertisement items) in the second display area 42. In one implementation, the electronic device 2 may randomly select one of the car advertisements for display at a time. In one implementation, each game stage/level may correspond to one of the car advertisements, and the electronic device 2 displays advertisement information of the car advertisement to which the game stage/level that is being played corresponds. For example, the electronic device 2 may display advertisement information of the first car advertisement in the second display area 42 when the game item is executed in a first game stage/level according to the game data, and display advertisement information of the second car advertisement in the second display area 42 when the game item is executed in the second game stage/level according to the game data. The display of the corresponding car advertisement may be repeated until the game player beats the game stage/level.

In one implementation, the game player may operate the electronic device 2 to select car advertisements to be associated with the stage beating game according to a geographical location of the electronic device 2. In detail, the electronic device 2 includes a global position system (GPS) device. The game server 1 stores geographical information of a plurality of geographical regions that are associated with the advertiser(s) providing the car advertisements, and correspondence information between each of the car advertisements and a corresponding one of the geographical regions. When the electronic device 2 is operated by the game player to log in the game server 1 to select a game item and an advertisement type in step 32, the electronic device 2 transmits coordinate information of the current geographical location thereof to the game server 1. The game server 1 determines which geographic region covers the current geographic location of the electronic device 2, and provides the car advertisement(s) corresponding to the geographic region thus determined to the electronic device 2 for user selection. For example, in a case where the first car advertisement corresponds to Taipei City and the second to fifth car advertisements correspond to Taichung City, when the game player operates the electronic device 2 to play the stage beating game in Taichung City, the game server 1 provides the second to fifth car advertisements for user selection. If the game player selects the third, fourth and fifth car advertisements to be associated with the stage beating game, the advertiser(s) of the selected car advertisements may provide corresponding rewards to the game player in response to the selection.

In summary, the embodiment of the in-game advertising method according to this disclosure uses the electronic device 2 to receive the game data of a game item and advertisement information of multiple advertisement items that are associated with the game item, to display the game content in the first display area 41 and to display the advertisement information in the second display area 42 different from the first display area 41, thereby attracting more attention from the game player on the advertisement information during the game play. In addition, since the time length of displaying the advertisement information of various advertisement items combined is almost the same of the entire gaming period, better advertising effect may be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of in-game advertising, comprising steps of:
(a) communicatively connecting an electronic device to a game server via a communication network, the game server including a game item and an advertisement item that corresponds to the game item;
(b) the electronic device receiving game data of the game item and advertisement information of the advertisement item from the game server; and
(c) the electronic device generating and displaying game content of the game item in a first display area according to the game data, and displaying the advertisement information of the advertisement item in a second display area that is non-overlapping with the first display area.

2. The method of claim 1, wherein the game server includes a plurality of the advertisement items that correspond to the game item; step (b) includes the electronic device receiving the advertisement information of the advertisement items; and step (c) includes the electronic device generating and displaying the advertisement information of the advertisement items in the second display area.

3. The method of claim 2, wherein step (c) includes the electronic device displaying, in response to execution of a first operation instruction associated with the game item according to the game data, advertisement information of a first one of the advertisement items in the second display area, and displaying, in response to execution of a second operation instruction associated with the game item according to the game data, advertisement information of a second one of the advertisement items in the second display area.

4. The method of claim 2, wherein step (c) includes the electronic device displaying the advertisement information of the advertisement items in a specific sequence.

5. The method of claim 2, wherein step (c) includes the electronic device displaying the advertisement information of the advertisement items randomly.

6. The method of claim 2, wherein the game content includes a first game stage and a second game stage, and step (c) includes displaying advertisement information of a first one of the advertisement items in the second display area when the game item is executed in the first game stage according to the game data, and displaying advertisement information of a second one of the advertisement items in the second display area when the game item is executed in the second game stage according to the game data.

7. The method of claim 2, wherein each of the advertisement items corresponds to a geographical region, and the game server stores correspondence information between each of the advertisement items and the corresponding geographical region, and;
wherein step (b) includes the electronic device receiving the advertisement information of the advertisement items, the corresponding geographical region of each of which covering a geographical location of the electronic device.

8. The method of claim 1, wherein step (c) includes the electronic device displaying an interactive section, said method further comprising a step of the electronic device saving the advertisement information in response to a user operation on the interactive section.

9. A method of in-game advertising, said method being implemented by a game server that is communicatively coupled to an electronic device via a communication network, the game server including a game item and an advertisement item that corresponds to the game item, said method comprising a step of the game server transmitting game data of the game item and advertisement information of the advertisement item to the electronic device;
wherein the game data causes, after execution by the electronic device, the electronic device to generate and display game content of the game item in a first display area, and to display the advertisement information of the advertisement item in a second display area that is non-overlapping with the first display area.

10. An in-game advertising system comprising:
a game server communicatively coupled to an electronic device via a communication network, including a game item and an advertisement item that corresponds to the game item, and configured to transmit game data of the game item and advertisement information of the advertisement item to the electronic device in response to a specific user operation from the electronic device;
wherein the game data causes, after execution by the electronic device, the electronic device to generate and display game content of the game item in a first display area, and to display the advertisement information of the advertisement item in a second display area that is non-overlapping with the first display area.
